(19) United States
(12) Patent Application Publication
(10) Pub. No.: US 2015/0085370 A1
(43) Pub. Date: Mar. 26, 2015

(54) BEAM-STACKING ELEMENT FOR DIODE-LASER BAR STACK

(71) Applicant: Coherent, Inc., Santa Clara, CA (US)

(72) Inventors: Andrea CAPRARA, Palo Alto, CA (US); John H. JERMAN, Palo Alto, CA (US)

(73) Assignee: Coherent, Inc., Santa Clara, CA (US)

(21) Appl. No.: 14/035,775

(22) Filed: Sep. 24, 2013

(51) Int. Cl. G02B 27/30

(52) U.S. Cl. CPC G02B 27/30
USPC 359/619

(57) ABSTRACT

Optical apparatus includes a diode-laser bar stack having N fast-axis stacked diode-laser bars cooperative with a parallel sided transparent stacking plate. The stacking plate receives N original beams from the N diode-laser bars and converts the N beams to 2N fast-axis stacked beams having one-half of a width the original beams and one-half of a fast-axis spacing between the original beams.

### TECHNICAL FIELD OF THE INVENTION

The present invention relates in general to two dimensional arrays of diode-lasers. The invention relates in particular to vertical stacks of one-dimension arrays of diode-lasers (diode-laser bars).

### DISCUSSION OF BACKGROUND ART

Vertical diode-laser bar stacks are now used for providing optical pump radiation for high-power (1 KW) fiber lasers. One such vertical diode-laser bar stack is schematically depicted in FIG. 1A and FIG. 1B. Details of one-example of the stack construction are depicted in FIG. 1B. Here, each diode-laser bar 17 is mounted on the front of a corresponding heat sink member 19. The heat-sink members are clamped together between clamping and mounting blocks 23A and 23B. Each heat-sink member has a forward-extending portion 21 to which a fast-axis collimating (FAC) lens or a module including a FAC lens and a slow-axis collimating (SAC) lens array can be attached.

A 26-bar stack such as stack 18, with nineteen emitters per bar, can deliver radiation having a total power of about 1.4 kW. Such diode-laser bars are designated by practitioners of the art as having a slow-axis (low divergence axis) aligned with the length of the diode-laser bar; a fast-axis (high divergence axis) perpendicular to the slow-axis, and a propagation-axis perpendicular to both the fast and slow axes. The slow-axis, fast-axis, and propagation-axis are alternatively designated as the x-axis, y-axis, and z-axis by practitioners of the art.

Referring to FIG. 1A, each of the diode-laser bars has a dedicated cylindrical fast-axis collimating (FAC) lens 20, which, as the name suggests, collimates light from each emitter in the bar in the highly divergent fast-axis direction. In this example, there are twenty-six lenses 20. Spaced apart from each FAC lens in the z-axis direction is an array 22 of cylindrical slow-axis collimating (SAC) lenses 24. The number of lenses 24 in each array 22 corresponds with the number of spaced-apart emitters (diode-lasers) in each of the diode-laser bars. Here, it is assumed that there are nineteen (19) emitters in each bar. Each SAC lens is aligned with a corresponding emitter. The FAC lenses and SAC lens-arrays are held in alignment with each other by brackets 26 (shown on only one side in FIG. 1A for convenience of illustration). Assemblies of FAC and SAC lenses are available from several commercial suppliers.

In such a diode-laser bar stack the vertical (fast-axis separation) of beams from adjacent diode-laser bars is limited by the thickness of the diode-laser bar substrates and the thickness of water cooled sub-mounts for the diode-laser bars. The fast-axis brightness of all combined beams from the diode-laser bar stack is limited by the fast-axis separation of the beams. The amount of the combined radiation that can be focused into an optical fiber at any particular numerical aperture is directly dependent on the total power and brightness of the radiation from the bar stack and the beam parameter product (BPP) of the focused radiation.

Generally, the approach to optimizing (minimizing) the focused BPP is to limit the height of the stack, and limit the fill-factor (the ratio of total of emitter widths to the total length of the bar). The height of the stack can be limited, for any given pitch of the diode-laser bars in the stack, simply by limiting the number of diode-laser bars in the stack. A convenient compromise has been found to be a stack of 13 bars, each 10 mm long and with a fill factor of 18%, with a pitch of about 3.3 millimeters (mm). In the fast-axis, the etendue can be reduced by reducing the height of the stack, for example, by limiting the number of the vertically stacked bars.

Various approaches have been suggested for limiting the fast-axis extent of a combined radiation output from a diode-laser bar stack using optical arrangements to reduce the fast-axis spacing between beams from a fixed number of diode-laser bars. A number of such approaches is described in detail in U.S. Pat. No. 6,993,059, assigned to the assignee of the present invention and the complete disclosure of which is hereby incorporated herein by reference.

The simplest of these approaches uses a parallel-sided glass block in front of a diode-laser bar stack and titled away from the stack in the fast-axis. The lower part of the block on a first side thereof closest the diode-laser bar stack has an array of spaced-apart reflective strips aligned with the fast-axis of the diode-laser bars. The number of reflective strips is one-half the number of diode-laser bars and the pitch of the strips is equal to the pitch of the diode-laser bars. On the opposite (second) side of the block, above the strips in the fast-axis direction, is a reflectively coated area. Beams from the lower bars in the stack pass between the strips on the first side of the block and under the coating on the second of the bloc. Beams from the upper bars in the stack pass over the array of strip through the first side of the block are reflected by the coated area on the second side and onto the reflective strips; and are reflected by the reflective strips interspersed between beams transmitted through the strips. While this approach provides a simple means of increasing fast-axis brightness, the approach does not provide for increasing the BPP of the focused combined beams.

### SUMMARY OF THE INVENTION

In one aspect, optical apparatus in accordance with the present invention comprises a plurality N of diode laser-bars characterized as having a slow-axis in a length direction, a fast-axis perpendicular to the slow-axis, and a propagation-axis perpendicular to the slow-axis and the fast-axis. The diode-laser bars are stacked one above another in the fast-axis direction with a predetermined pitch P therebetween. A plurality N of fast-axis collimating lenses is provided one for each of the diode-laser bars and a plurality N of slow-axis collimating lens arrays is provided, one for each of the diode-laser bars, the diode-lasers bars. The fast-axis collimating lenses, and slow-axis collimating lenses provide a plurality N of combined-radiation beams propagating one above another in the fast-axis direction parallel to the propagation-axis direction. Each beam has a width W in the slow-axis direction. A transparent plate is located in the path of the combined radiation beams. The transparent plate has a thickness and first and second opposite surfaces parallel to each other. The surface are inclined to the fast-axis direction at a first angle, and inclined to the slow-axis direction at a second angle. The first surface of the plate faces the diode-laser bar stack. First and second internally reflective coatings partly cover respectively the first and second surfaces of the plate. The first and second internally reflective coatings are configured and the thickness of the plate and the first and second angles are selected such that the plate transmits 2N combined beams propagating one above another in the fast-axis direction parallel to each other in the propagation-axis direction, with each beam having a width less than W in the slow-axis direction, and with the beams spaced apart in the fast-axis direction by a distance of about P/2.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1A is an isometric three-dimensional view schematically illustrating one aspect of a prior-art vertical diode-laser bar stack.

FIG. 1B is an isometric three-dimensional view schematically illustrating another aspect of the prior-art vertical diode-laser bar stack of FIG. 1.

FIG. 2 is a three dimensional view schematically illustrating a preferred embodiment of optical apparatus in accordance with the present invention including a fast-axis diode-laser bar stack and a stacking plate allowed to create two fast-axis stacked beams from a combined beam emitted by each of the diode-laser bars, with the created beams having about one-half of a width the original beams and having a fast-axis separation about one-half of a fast-axis separation of the original beams.

### DETAILED DESCRIPTION OF THE INVENTION

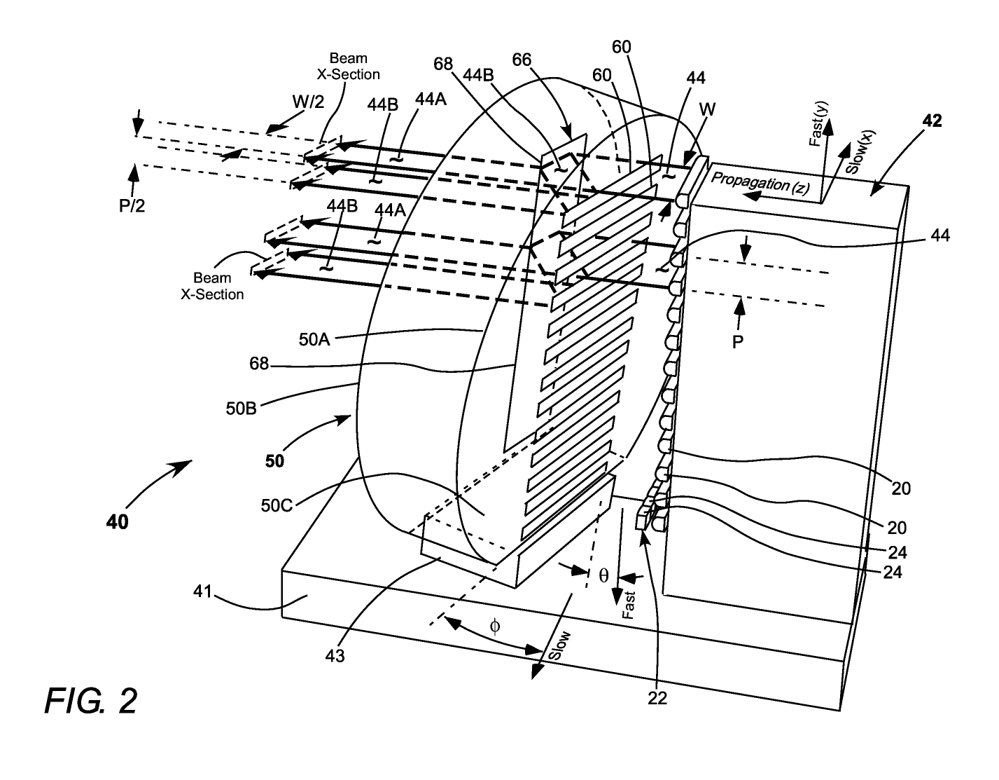

Referring now to the drawings, wherein like components are designated by like reference numerals, FIG. 2 schematically illustrates one-preferred embodiment of optical apparatus 40 in accordance with the present invention apparatus in accordance with the present invention including a vertical stack 42 of diode-laser bars and an inventive beam-processing plate 50 for increasing the fast-axis brightness of combined beams 44 from the diode-laser bar stack. The diode-laser bar stack is mounted on a base 41 can be considered as a simple version of the above described diode-laser bar stack with only 13 diode-laser bars stacked. Only sufficient detail of the diode-laser bar-stack is shown in FIG. 2 for understanding principles of the present invention.

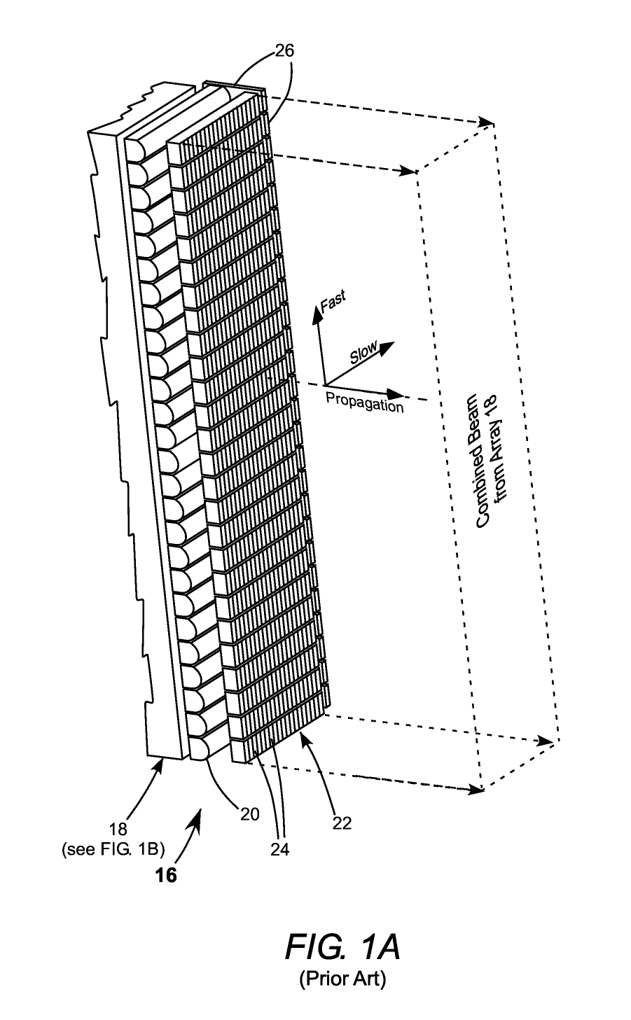

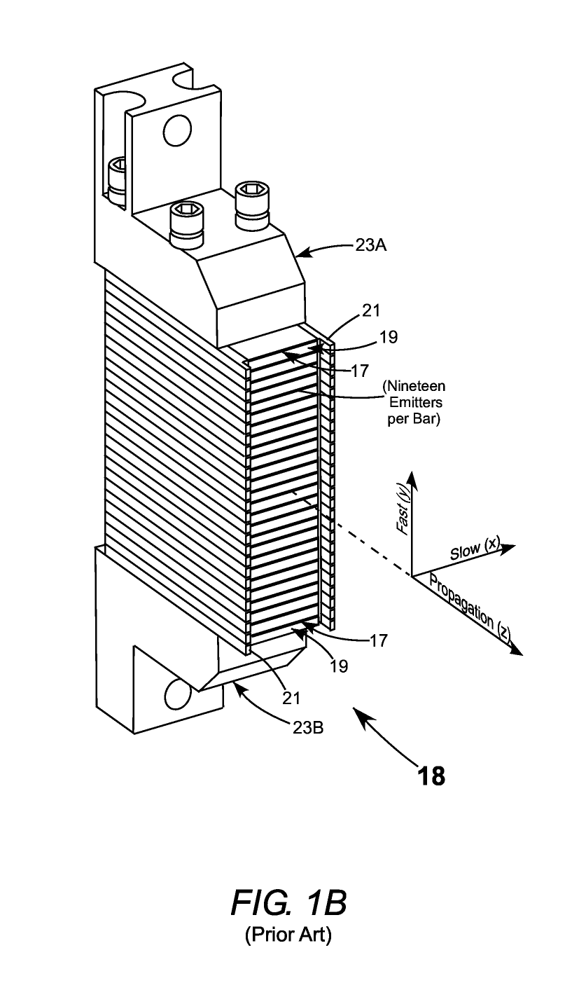

Only two beams 44 from the diode-laser bar stack are shown, for simplicity of illustration. Beams from the diode-laser bars are collimated in both the fast-axis and the slow-axis as described above with reference to FIG. 1A and FIG. 1B. All fast-axis collimating lenses 20 are depicted in FIG. 2, but only one slow-axis collimating lens array 24 is shown, again for convenience of illustration. The collimating lens-array has a number of individual collimating lenses corresponding to the number of emitters (not shown) in the diode-laser bar. Beams 44 have a width W between bounding rays depicted by bold lines. The beams have a fast-axis spacing (pitch) P indicated in FIG. 2 as the fast-axis distance between apexes of adjacent fast-axis collimating lenses.

Beam processing plate 50 has parallel faces 50A and 50B. A base 50C of plate 50 is bonded to slightly wedge-shaped mounting block 43 attached to base 41. On face 50A of plate 50 is a parallel array of strips 60 which are highly reflective for the diode-laser radiation, at least (internally) on the side facing into the plate. The array of strips has a pitch P corresponding to the pitch of the diode-laser bars in the stack. In the illustrated embodiment, each strip is as long as the beams 44 are wide. The height of strips 60 is sufficient to completely intercept the fast-axis height of a beam 44. Spaces between strips 60 are wide enough to allow the fast-axis height of a beam 44 to pass between adjacent strips. The parallel array of strips 60 is aligned parallel to the x-z plane of the diode-laser bars.

Plate 50 is tilted (tipped) toward the fast-axis of the diode-laser bars by an angle θ, and rotated away from the slow-axis of the diode-laser bars by an angle φ. On face 50B of plate 50 is coating 66, here rectangular in shape and at least internally reflective. Coating 66 has a straight edge 68 aligned parallel to the fast-axis of the diode-laser bars. Edge 68 is aligned about centrally in the width of beams 44 within the plate. Coating 66 in the slow-axis direction has a width greater than half of the width of beams 44. Coating 66 has a length in the fast-axis direction of the diode laser bars at least sufficient to intercept all beams 44 within plate 60. It is recommended that portions of faces 50A and 50B not having reflective coatings 66 or 60 thereon are anti-reflection coated for the wavelength of radiation from the diode-laser bars.

The function of plate 50 can be followed by following the progress of a beam 44 from the uppermost diode-laser into, through and out thereof. One half-portion of the beam-width is intercepted by reflective coating 66 allowing the other half portion 44A to be transmitted through face 50B of the plate in the propagation-axis direction.

The half-portion 44B intercepted by coating 66 is reflected downwards and laterally onto the uppermost reflective strip under the transmitted portion 44A. The strip 60 reflects beam-portion 44B in the propagation-axis direction such that beam-portion 44B leaves plate 60 under transmitted beam portion 44A at a level below the level of beam-portion 44A in the z-axis direction.

The processing of a beam 44 from any other than the uppermost will require that the beam pass between two adjacent strips 60 as illustrated, but will otherwise be the same. Beam cross-sections are indicated by elongated dashed rectangles to assist in following the beam progress described above.

In an example of stacking plate 50 for a diode-laser bar stack having a pitch P of about 3.3 mm, the plate is a fused silica plate having a thickness of about 12 mm. Angle θ is about 5.9 degrees and angle φ is about 17.3 degrees. The reflective coatings are preferably multilayer dielectric coatings.

The effect of processing (stacking) plate 50 is to take the original number of beams from the diode-laser bar stack and create therefrom twice as many beams half as wide (W/2) as the original beam, with a separation P/2 therebetween, i.e., half of the pitch (P) of bars in stack 42. The slow-axis divergence of the two beams obtained from each original beam will be essentially the same as that of the original beam.

As the slow-axis etendue of the beams stacked by the plate will be essentially half of the etendue of the original beams, this can provide for a reduced BPP of the focused beams in the slow-axis direction. The BPP in the fast-axis direction will not change appreciably, since the total width of the beam in the fast-axis direction will only increase from N times the pitch to N+½ times the pitch, where n is the number of bars.

Alternatively, each of the stacked beams can be made to have the slow-axis etendue of the original beams by increasing, i.e., doubling, the fill factor of the diode-laser bars, say from the above-discussed 18% to 36%. This can about double the total power in the beams without any reduction in BPP. In other words, the 13-bar diode-laser bar stack of FIG. 2 will have about the same power-output as the prior art diode-laser bar stack of FIGS. 1A and 1B.

It should be noted here, that while it may be preferable to have all beam portions 44A and 44B aligned one above the other in the fast-axis direction, the 44A beams and the 44B beams may be slightly displaced one from another in the slow-axis direction without significantly adversely affecting any of the above discussed advantages of the arrangement of diode-laser bar stack and inventive stacking plate 50. Those skilled in the art will also recognize that coating 66 could be an array of parallel strips similar to strips 60 with the array staggered such that strips of coating 66 intercepted the beams passing between or over strips 60.

In summary, the present invention is described above with reference to preferred and other embodiments. The invention is not limited, however, to the embodiments described and depicted. Rather the invention is limited only by the claims appended hereto.

What is claimed is:

1. Optical apparatus, comprising:
a plurality N of diode laser-bars characterized as having a slow-axis in a length direction, a fast-axis perpendicular to the slow-axis, and a propagation-axis perpendicular to the slow-axis and the fast-axis, the diode-laser bars stacked one above another in the fast-axis direction with a predetermined pitch P therebetween;
a plurality N of fast-axis collimating lenses one for each of the diode-laser bars and a plurality N of slow-axis collimating lens arrays, one for each of the diode-laser bars, the diode-lasers bars, fast-axis collimating lenses, and slow-axis collimating lenses providing a plurality N of combined-radiation beams propagating one above another in the fast-axis direction parallel to the propagation-axis direction, each beam having a width W in the slow-axis direction;
a transparent plate in the path of the combined radiation beams, the transparent plate having a thickness and first and second opposite surfaces parallel to each other, the surfaces inclined to the fast-axis direction at a first angle, and inclined to the slow-axis direction at a second angle, with the first surface of the plate facing the diode-laser bar stack, and with first and second reflective coatings partly covering respectively the first and second surfaces of the plate; and
wherein the first and second reflective coatings are configured and the thickness of the plate and the first and second angles are selected such that the plate transmits 2N combined beams propagating one above another in the fast-axis direction parallel to each other in the propagation-axis direction, each beam having a width less than W in the slow-axis direction, and with the beams spaced apart in the fast-axis direction by a distance of about P/2.

2. The apparatus of claim 1, wherein each of the 2N combined beams has a width in the slow-axis direction of about W/2.

3. The apparatus of claim 2, wherein the slow-axis widths of the 2N combined beams are aligned with each other in the fast-axis direction.

4. The apparatus of claim 1, wherein the first reflective coating includes a plurality of N reflective strips parallel to the slow-axis direction and spaced-apart and aligned with the diode-laser bar stack to allow the plurality of N beams to be transmitted through the first surface of the transparent plate, and wherein the second reflective coating is configured to transmit a first portion of the slow-axis width of each of the N combined radiation beams through the second surface of the plate and to reflect a second portion of the slow-axis width of each of the N combined radiation beams back to a corresponding one of the reflective strips such that the second portions of the N combined radiation beams are reflected out of the transparent plate, through the second surface thereof between the N first portions of the combined radiation beams.

5. The apparatus of claim 1, wherein N is thirteen, P is about 3.3 millimeters, the transparent plate is made from fused silica and has a thickness of about 12 millimeters the first angle is about 5.9 degrees and the second angle is about 17.3 degrees.

6. The apparatus of claim 1, wherein the first and second reflective coatings are multilayer dielectric coatings.

7. An optical apparatus comprising:
a stack of elongated laser bars each generating a beam of radiation having a slow axis in the length direction and a fast axis perpendicular thereto;
a plurality of lenses for collimating the light from the bars in both the fast and slow axis; and
a transparent plate aligned with the bar stack and having opposed input and output surfaces, with the width of the plate being aligned with the slow axis of the stack, with the plate being tilted with respect to the fast axis of the stack and rotated with respect to the slow axis of the stack, said transparent plate having a reflective coating on the output surface thereof extending about halfway across the width of the plate so that about one half the width of each beam is transmitted past said reflective coating with the other half width of the beams being reflected towards the input surface of the plate both downwardly and to the side in the width direction, said input surface of the plate including an array of reflective strips positioned so that light originally entering the plate from the stack is transmitted through the spaces between the array and wherein light reflected back towards the input surface from the reflective strip is reflected again back towards the output surface and exits the plate interleaved with the portions of the beams originally transmitted past the reflective coating.
